(19) United States
(12) Patent Application Publication
(10) Pub. No.: US 2011/0193795 A1
(43) Pub. Date: Aug. 11, 2011

(54) HAPTIC SEARCH FEATURE FOR TOUCH SCREENS

(75) Inventors: Ariel Seidman, Palo Alto, CA (US); Olivia Raebel Franklin, Santa Clara, CA (US); Ashley Hall, Menlo Park, CA (US); Aaron Joseph Wheeler, San Francisco, CA (US)

(73) Assignee: Yahoo! Inc., Sunnyvale, CA (US)

(21) Appl. No.: 12/862,324

(22) Filed: Aug. 24, 2010

Related U.S. Application Data
(60) Provisional application No. 61/302,953, filed on Feb. 9, 2010.

(51) Int. Cl. G06F 3/041

(52) U.S. Cl. 345/173

(57) ABSTRACT

A search method includes steps of: receiving information required to render a first map of a geographical area on a touch screen display; delivering the map for presentation on a first visual area rendered on the touch screen display; receiving from a user of the touch screen display a selection of a target search area within the geographical area, wherein the user desires to restrict a search for items of interest to said target search area, wherein said selection of the target search area is produced by the user drawing a shape encompassing at least a portion of the target search area over the first map presented on the touch screen display.

### CROSS-REFERENCE TO RELATED APPLICATIONS

This is a non-provisional of, and claims priority from, U.S. patent application Ser. No. 61/302,953, filed on Feb. 9, 2010 and entitled “Sketch-a-Search,” which application is incorporated by reference herein.

### STATEMENT REGARDING FEDERALLY SPONSORED-RESEARCH OR DEVELOPMENT

None.

### INCORPORATION BY REFERENCE OF MATERIAL SUBMITTED ON A COMPACT DISC

None.

### FIELD OF THE INVENTION

The invention disclosed broadly relates to the field of search and more particularly relates to the field of search for touch screen devices.

### BACKGROUND OF THE INVENTION

Providing and improving geographic (geo) search technology, particularly for mobile applications (apps) has become a focus of major search companies. The improved ability to locate and identify businesses through geo search, particularly in mobile devices, is recognized as a tremendous boon to businesses and advertisers alike. Formulating a query with geo search technology requires as input: the query object (restaurants, offices), the location, and the semantic relation between the query object and the location (at, east of, outside of, inside of, nearby, etc.). Discerning the location is usually delegated to servers in communication with the mobile device via mobile gateway interface.

In geo search, the location can be specified using names (e.g., Palo Alto), postal codes (e.g., 94303), and geographic coordinates (e.g., Lat/Lon 37.47/122.12). The goal of search is to provide the most relevant results. Searches today are keyword based. As an example of current geo search models, assume a user is searching for local restaurants in San Francisco. The user supplies the query object (Mexican restaurant), and the location (San Francisco). The semantic relation is usually not explicitly provided, but assumed to be “in.” In this example, the user enters a query such as “Mexican food marina San Francisco” which requires the user to know the name of the neighborhood for the target restaurant. This information is not always known, but is required in today's geo searches in order to get relevant results.

Moreover, in some cases the information is known, but it is too difficult or even impossible to know which keywords to use to formulate the search query in order to achieve the desired result. For example assume a user is searching for commercial office rentals in San Francisco close to the water, but not on the waterfront, not in a retail area, but close to a trolley stop. Using the keywords “San Francisco,” “office rental, water, trolley stop” would probably not bring up the desired results, because of difficulties in query disambiguation. The search query would return available offices near the water, including waterfront space which the user did not want. It is difficult to disambiguate the undesirable search candidates partly because of the difficulty in expressing a semantic relation such as “nearby but excluding.” In addition, certain features which may be viewable on a map, such as trolley stops, are not expressed in search engines, therefore they are not picked up by a search query.

Search applications for mobile devices have evolved to include geographic maps. One such application currently sold for the iPhone is shown in FIG. 23, “LoopNet® Commercial Real Estate Search” by LoopNet.com. FIG. 23 is a screenshot of the search type selection page. FIG. 24 shows a filter page which defaults to the user's current location. FIG. 25 shows the results page indicating the query results based on the filter selections. This results page highlights one of the shortcomings of this and similar search tools in that the query returned waterfront offices because it was not possible for the user to exclude them.

Continuing with this example, FIG. 26 shows a detail page of one selected result and FIG. 27 shows an image selected from the detail page. The drawback to this application and other known geo searches is the inability to adequately express semantic relations in order to properly disambiguate the query. This is necessary in order to provide a valuable search experience.

Therefore, there is a need for a non-keyword search capability to overcome the shortcomings of the known art.

### SUMMARY OF THE INVENTION

Briefly, we describe a computer-implemented method for non-keyword searching according to an embodiment of the present invention. The method includes: receiving information required to render a first map of a geographical area on a touch screen display; delivering the map for presentation on a first visual area rendered on the touch screen display associated with a computer in use by a user; and receiving from the user a selection of a target search area within the geographical area wherein the user desires to restrict a search for items of interest, wherein the selection of the target area is produced by the user drawing a shape encompassing at least a portion of the target area over the first map presented on the touch screen display. Responsive to receipt of the drawing, the method proceeds by accepting the shape of the drawing; recognizing the shape as a boundary; and identifying the boundary as representing the target area for restricting the search. Further, the method causes a search for the items of interest located within the boundary, wherein the search is executed on a query including the item of interest and the target area, excluding any items of interest not located within the target area; and returning query results to the user by indicating on the touch screen display those results matching the items of interest located within the boundary represented by the drawn target area.

According to another embodiment of the present invention, we describe a system for computer-implemented search including: a device that includes a touch screen display; a processor device operatively coupled with the touch screen display, and a memory for storage of operational instructions for execution by the processor device. The device also includes an interface to a search feature and an interface to a geo location/mapping feature.

According to the invention, the processor device is operable for: receiving information required to render a first map of a geographical area on the touch screen display; delivering the map for presentation on a first visual area rendered on the touch screen display; receiving from a user of the touch screen display a selection of a target search area within the geographical area wherein the user desires to restrict a search for items of interest, wherein said selection of the target search area is produced by the user drawing a shape encompassing at least a portion of the target search area over the first map presented on the touch screen display; and responsive to receipt of the drawing the processor device is operable for: accepting the shape of the drawing; recognizing the shape as a boundary; and identifying the boundary as representing the target search area for restricting the search.

The processor device is further operable for executing a search for the items of interest located within the boundary, wherein the search is executed on a query including the item of interest and the target search area, wherein the query excludes any items of interest not located within the target search area; and returning query results to the user by indicating on the touch screen display those results matching the items of interest located within the boundary represented by the drawn target search area.

According to another embodiment of the present invention, we describe a computer program product comprising a non-transitory computer readable storage medium with program instructions which, when executed, case a computer to perform the method steps as described above.

### BRIEF DESCRIPTION OF THE SEVERAL VIEWS OF THE DRAWINGS

To describe the foregoing and other exemplary purposes, aspects, and advantages, we use the following detailed description of an exemplary embodiment of the invention with reference to the drawings, in which:

FIG. 1 is a process flow diagram of a sketch-a-search application according to an embodiment of the present invention;

FIG. 2 shows the start of the application wherein the logo becomes animated as the application downloads, according to an embodiment of the present invention;

FIG. 3 shows the Agree Use Location overlay, according to an embodiment of the present invention;

FIG. 4 shows the Locate Me default screen, according to an embodiment of the present invention;

FIG. 5 shows the viewport in draw mode, according to an embodiment of the present invention;

FIG. 6 shows an initial draw action on the viewport, according to an embodiment of the present invention;

FIG. 7 shows the pins dropping in response to the query, according to an embodiment of the present invention;

FIG. 8 shows the viewport in results mode, according to an embodiment of the present invention;

FIG. 9 shows details of the selected result, according to an embodiment of the present invention;

FIG. 10 shows the “Not a Fan” option, according to an embodiment of the present invention;

FIG. 11 shows the filter mode, according to an embodiment of the present invention;

FIG. 12 shows the places mode, according to an embodiment of the present invention;

FIG. 13 shows the initial locate mode screen, according to an embodiment of the present invention;

FIG. 14 shows the manual situate me metro view, according to an embodiment of the present invention;

FIG. 15 shows the low zoom factor pre-draw view, according to an embodiment of the present invention;

FIG. 16 shows the zoom and position by cluster mode, according to an embodiment of the present invention;

FIG. 17 shows the low zoom factor draw mode, according to an embodiment of the present invention;

FIG. 18 shows the low zoom factor drawn area auto-zoom mode, according to an embodiment of the present invention;

FIG. 19 shows a simplified diagram of a device configured to operate according to an embodiment of the present invention;

FIG. 20 shows details of a line draw, according to an embodiment of the present invention;

FIG. 21 shows the share and social poll feature, according to an embodiment of the present invention;

FIG. 22 is a high level block diagram showing an information processing device according to another embodiment of the invention;

FIG. 23 is a screenshot of a search type selection page from a search application sold for mobile phones, according to the known art;

FIG. 24 is a screenshot of a filter page of the search application of FIG. 23, according to the known art;

FIG. 25 is a screenshot of the results page of the search application of FIG. 23, according to the known art;

FIG. 26 is a screenshot of the detail page of the search application of FIG. 23, according to the known art;

FIG. 27 is a screenshot of an image from the detail page of FIG. 26, according to the known art;

FIG. 28 is a simplified diagram of a mall guide embodiment configured to operate according to an embodiment of the present invention;

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

In the following description of the invention, we disclose various embodiments that incorporate the features of the invention. The descriptions of the various embodiments serve to illustrate and exemplify the invention such that one with knowledge in the art may be able to understand the invention as presented and reduce it to practice. The scope of the invention is not to be construed as limited to the disclosed embodiments, but instead the scope of the invention shall be defined by the appended claims.

In the following description, numerous specific details are set forth by way of exemplary embodiments in order to provide a more thorough description of the present invention. It will be apparent, however, to one skilled in the art, that the present invention may be practiced without these specific details. In other instances, well-known features have not been described in detail so as not to obscure the invention. The preferred embodiments of the inventions are described herein in the Detailed Description, Figures, and Claims. Unless specifically noted, it is intended that the words and phrases in the specification and claims be given the ordinary and accustomed meaning as understood by those of skill in the applicable art. If any other meaning is intended, the specification will specifically state that a special meaning is being applied to a word or phrase.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As used throughout, “touch screen” indicates the touch sensitive panels coupled with an underlying high resolution graphical electronic display that are found in many computing systems today, such as mobile phones, laptops, and larger devices such as touch screen kiosks and touch screen mall guides. In a touch screen device, the underlying electronic display is able to effect data capture in response to touch navigation in order to update the image presented on the panel. Haptic (tactile) stimulation of the panel produces an identical effect as if a mouse and/or keyboard was used to make selections. The underlying technology of drawing displays is known, varied, and beyond the scope of the invention and requires no further elaboration in this document. This technology is aptly described in numerous publications and patents, including U.S. Pat. No. 6,738,050 entitled “Microencapsulated Electrophoretic Electrostatically Addressed Media for Drawing Device Applications” filed on Sep. 16, 2001.

We discuss a sketch-based search system, method, service, and apparatus for touch screen devices that affords a user a rich search experience without having to input keywords. Further, the sketch-based method allows more meaningful expression of semantic relationships between query objects and their location because it enables exclusion by enabling relations such as “nearby, but not adjacent.” The search process can be location-specific without requiring the user to enter a location by typing on a keyboard. In fact, the keyboard is not necessary and can be hidden from view.

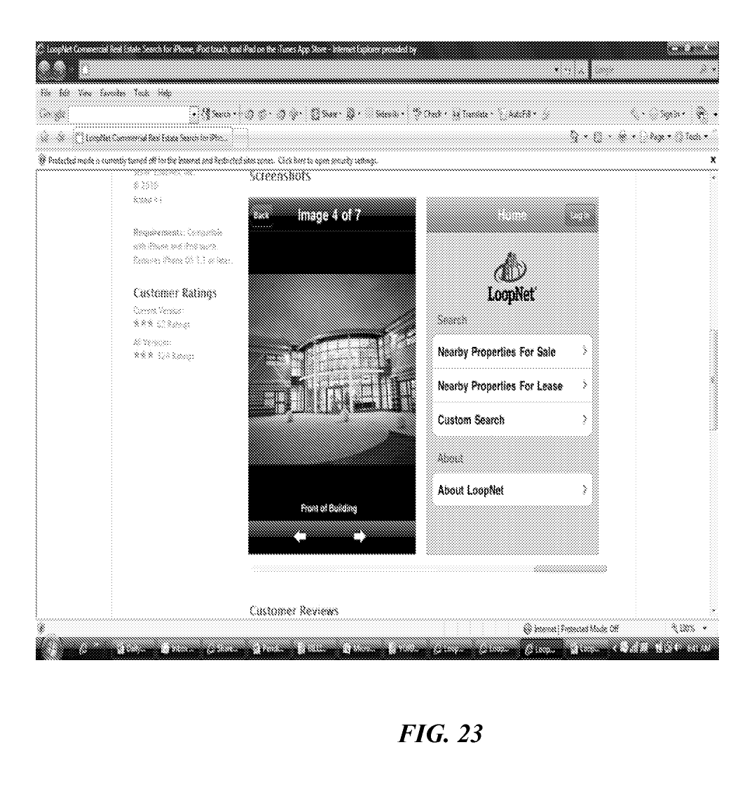

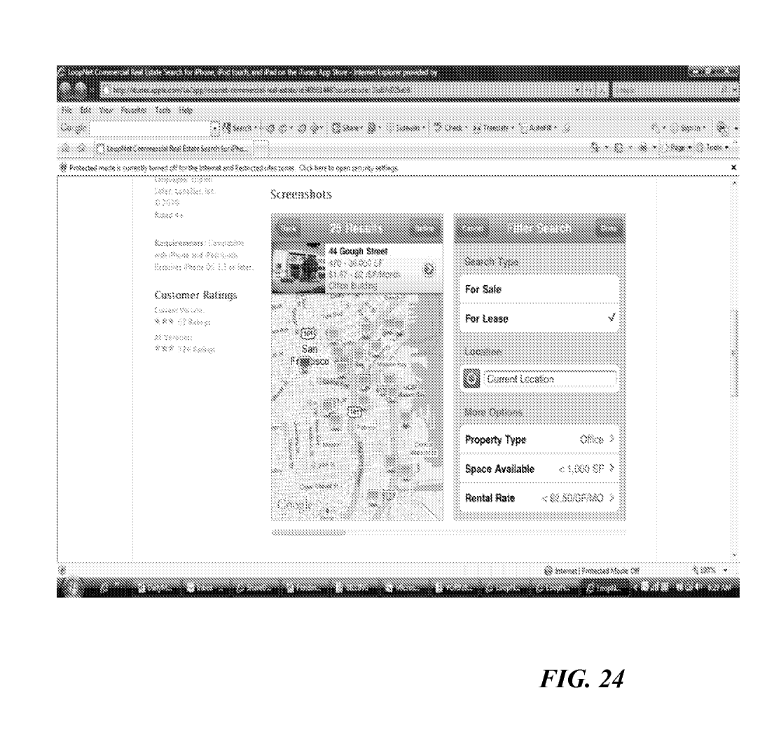

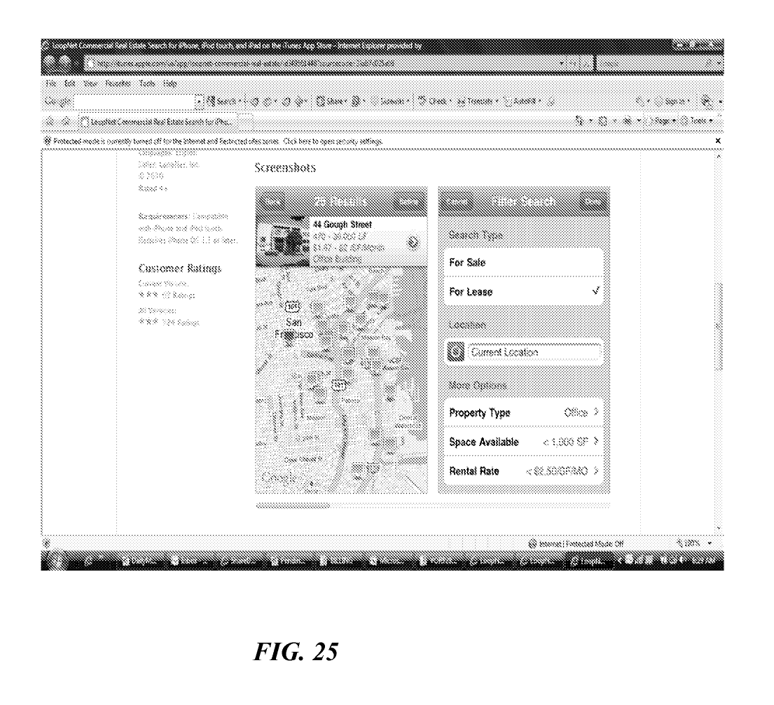

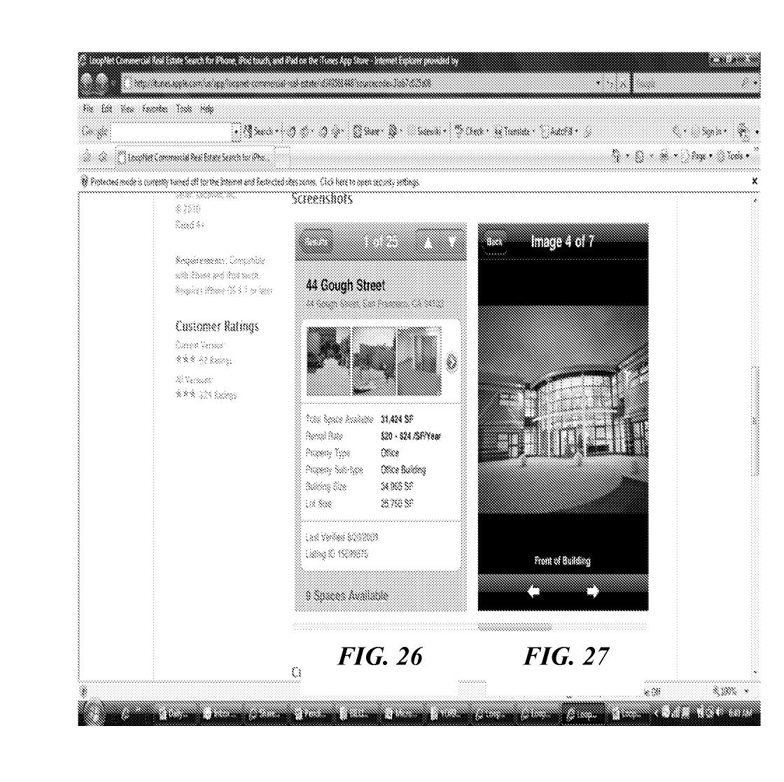

In the sketch-based method according to the invention, a search query is “drawn” by the user by simply sketching (by freehand drawing, or template) a search area on a map displayed on the viewport associated with the touch screen device. The advantage here is that, unlike the example discussed with respect to FIGS. 23 through 27, the user is able to express the relational concept of “nearby, but excluding . . . ” because the user can draw the search area to exclude objects that would normally be included in a keyword-based query.

The sketch or drawing can be a simple shape such as a circle, oval, square, or even a straight line and does not have to be correctly proportioned to accommodate freehand drawing. The sketch can be generated by a user drawing directly on the touch screen with a finger or stylus. Localized results (available offices, restaurants, businesses, points of interest, and so forth) that fall within the drawn area are returned as query results; results that fall outside of the drawn area are not returned. The user is then able to filter the query results based on social signals (did my friends like this? food type, and many other filters).

A further advantage of the sketch-based search is that zooming and panning interactions are enabled on the map once the search area is “drawn.” This allows the user to more specifically target an area and then re-draw another search area on the zoomed or panned map display. The newly drawn search area replaces the previous search area in the query.

A further advantage is gained in that the sketch search is able to generate clusters of items of interest to assist the user in locating interesting areas within a city. Rather than requiring users to know the neighborhood/cities of each area they want to search or requiring them to enter multiple neighborhood searches e.g. “Mexican food Noe Valley” and then “Mexican food Mission,” or “Mexican food downtown” a user is able to search for specific areas within each of these neighborhoods all at once by simply drawing an object within the areas of these neighborhoods. Throughout this discussion we use restaurants as an example of an item of interest. However, it should be noted that other items of interest (such as doctors, ATMs, gas stations, real estate listings, and others) could also be substituted as items of interest to be searched.

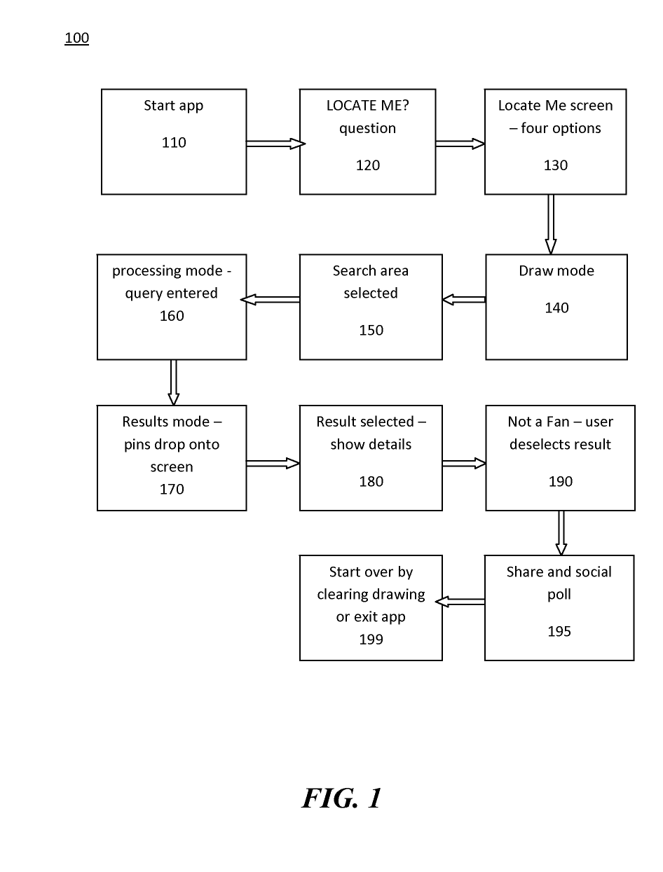

Referring now in specific detail to the drawings, and particularly to FIG. 1, there is illustrated a high level process flow diagram 100 of a sketch search method according to an embodiment of the invention. The requirement for this method is a touch screen and logic for operating the touch screen, and access to both search and geo location engines. The touch screen may be part of a cell phone, personal digital assistant, laptop, or other user device. Furthermore, the touch screen may be a stand-alone apparatus such as a touch screen kiosk and mall guide.

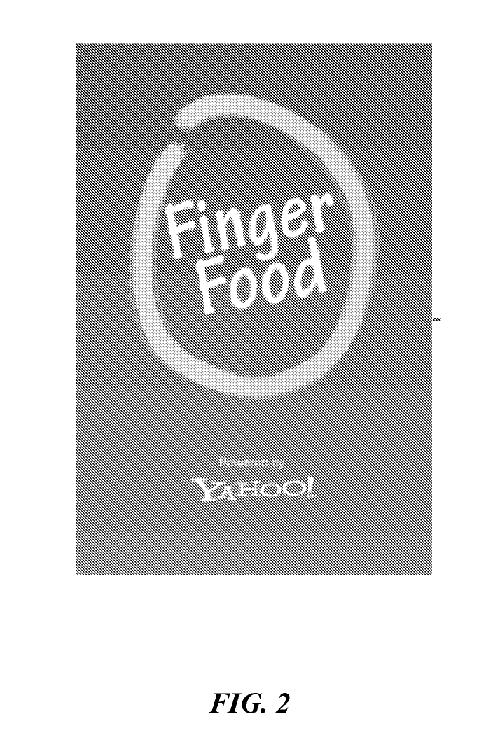

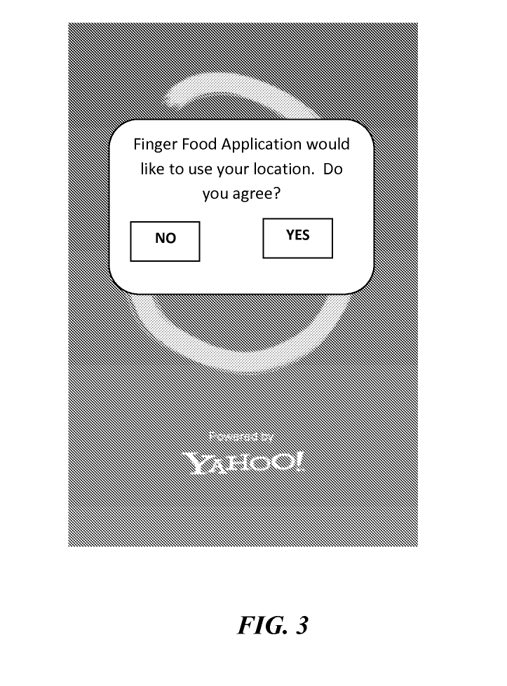

The method begins at step 110 after a user has selected the sketch search application from the user's touch screen phone and/or laptop (or other touch-screen device). Requirements for the device are a touch screen or touch pad capability and a mobile application gateway to a geo-location subsystem such as a GPS (Global Positioning System) and a search engine. Once the user selects the sketch search application, the logo of the application (app) will become animated. FIG. 2 shows an exemplary logo that is animated as the app loads. Next, in step 120 the Agree Use Location screen pops up, overlaying the app logo. At this point the user is prompted to give permission to use the user's current location for the search. The user's current location, as determined by the geo-location subsystem, is the default. See FIG. 3 for an example of the Agree Use Location screen. Prior to this screen the user can explicitly select an item of interest (query object) from the touch screen by manipulating a drop-down menu, buttons, or other method.

The user may retain the default location by tapping the “Yes” button shown in FIG. 3. If, however, a different location is desired, the user selects “No.” For connection handling, there are two paths for this mode: 1) user does not agree to provide location: Disable Locate Me, only the “go to” feature is available; and 2) airplane mode: throw error: “Unable to load map: Please ensure that your device is connected to the Internet and then try again.”

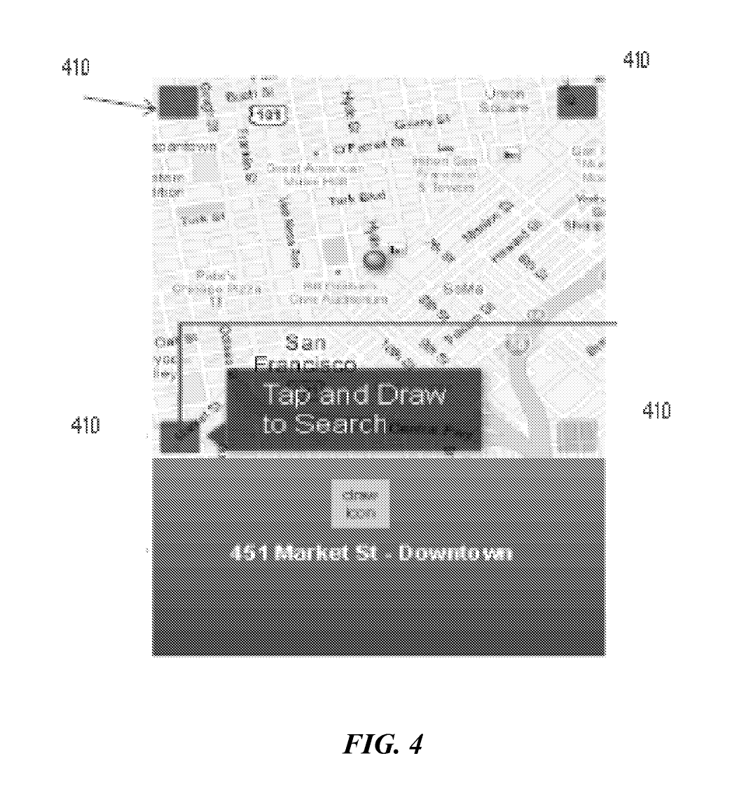

Once the location is selected in step 130, the Locate Me default screen 400 appears showing a map in the top portion of the viewport with the selected or default location centered within the map. This screen is shown in FIG. 4. Below the map in the bottom portion of the viewport, the current location is shown underneath a “draw icon” button.

Shown on the “Locate Me” screen, the user has access to four image buttons 410 (shown here for exemplary purposes only on each of the four corners of the screen). The four buttons 410 are: a) the draw mode button; b) the location button; c) the filter button; and d) the places button (the user's current location as address or the most accurate form possible). The image buttons 410 have a sufficiently large target area such that they can be easily pressed by a human finger, but are placed so as not to obstruct the image. Note that the appearance of the image buttons 410 will change according to the current state of the button 410. Three different states will be represented: 1) enabled; 2) selected; and 3) disabled. The different states may be indicated using colors, highlight, blinking, or other feature. At this point in the process, the draw, places, and locate buttons are shown as enabled, and the filter button is shown as disabled until the user sketches a search.

In its simplest form, in an alternative embodiment, no buttons are required and the draw mode is always enabled. Additionally, it is contemplated that other embodiments with different combinations of buttons and modes that actuate changes to the images presented in the touch screen display are within the spirit and scope of the invention.

In the “Draw Mode,” the map shown in the viewport is movable using conventional means such as swiping, panning, and pinch and zoom. The places and locate buttons are available should the user wish to re-situate the view prior to selecting the draw mode. The Draw Mode allows the user to sketch the search area. The Draw Mode is selected by tapping the draw button 410 on the lower left-hand side of the screen or by pressing a finger against the map surface for more than one second without moving the map.

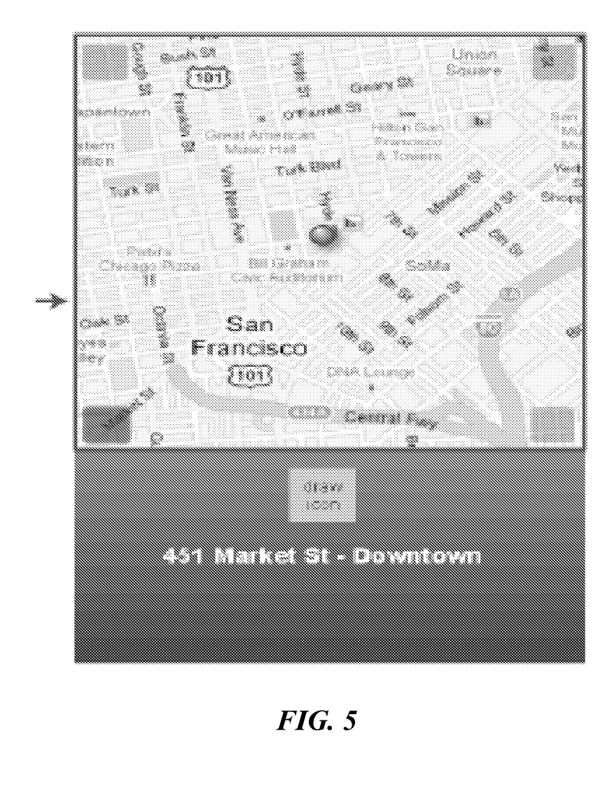

Next in step 140 the Draw Mode as shown in FIG. 5 has been selected by the user. In this mode, the map is outlined to provide a visual indication that it is currently in the Draw Mode. In Draw Mode: a) all actions are locked out other than drawing; b) the map is highlighted to show it is in draw vs. position mode; and c) a prompting icon appears in the lower area above the location indicator. Note that in Draw Mode the draw button indicates a state of “selected.”

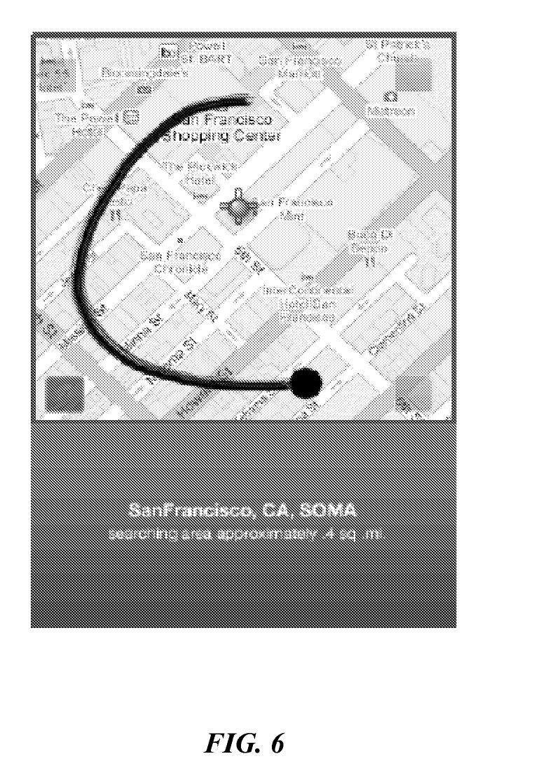

Once in Draw Mode, the user selects a search area in step 150 by a drawing action with a finger or stylus or other suitable touch-screen compliant instrument. Lines as well as closed selections can be drawn. See FIG. 6 for an example. Additionally, the sketch search method provides auto-complete of the drawing. Based on technical capability, a specific degree of “arc” and/or proportional distance between the beginning and end points of a line will determine if the selection should be auto-completed and define a closed area for searching or left as a line with a certain amount of margin on either side that is searched. The dimensions of the margin can be pre-defined.

In the example of FIG. 6 the user has drawn an arc to indicate a search area in San Francisco. Therefore, the arc of FIG. 6 is converted to a circle by the sketch search application by auto-completing using the boundaries of the arc. In one embodiment of the invention, as the user draws the shape, gentle audio sound will play. When the user stops drawing the audio fades out. When the user completes the drawing or the drawing is auto-completed a quick audio sound will play, such as a ding or beep.

Once the location has been drawn, lifting the finger from the touch screen automatically enters the selected location and the search query is processed. Multiple strokes for one query are not supported. To modify or cancel the query the user must tap the draw button again after the system begins to process. Tapping the draw button “erases” the current operation and results display and returns the user to the ready to draw state. The filter states and map location are retained unless the user changes them.

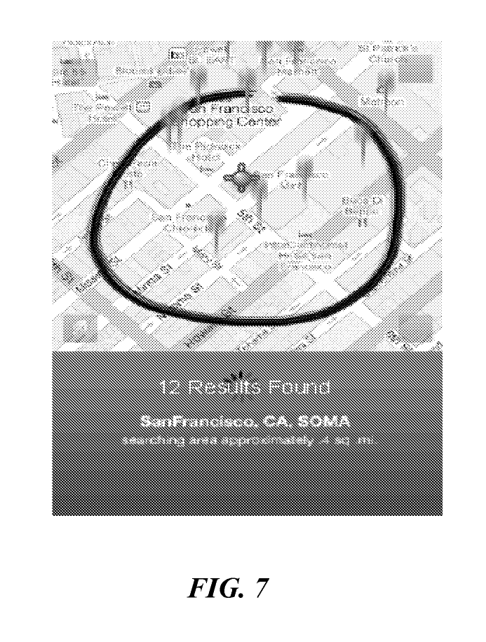

When the query is entered, in step 160 the screen is in processing mode. This is shown in FIG. 7. In processing mode, once a desired search area has been drawn the map auto-zooms to maximize the drawn area within the viewport to the highest possible degree of resolution. While the search is being processed, the lower section of the screen shows the processing animation with the number of search query results and the search area reference point (the default or selected location) at the highest level of resolution possible. In processing mode, we show: 1) exact location if known and on the screen; 2) cluster area if clearly determinable; 3) metro area if no more specific location is available.

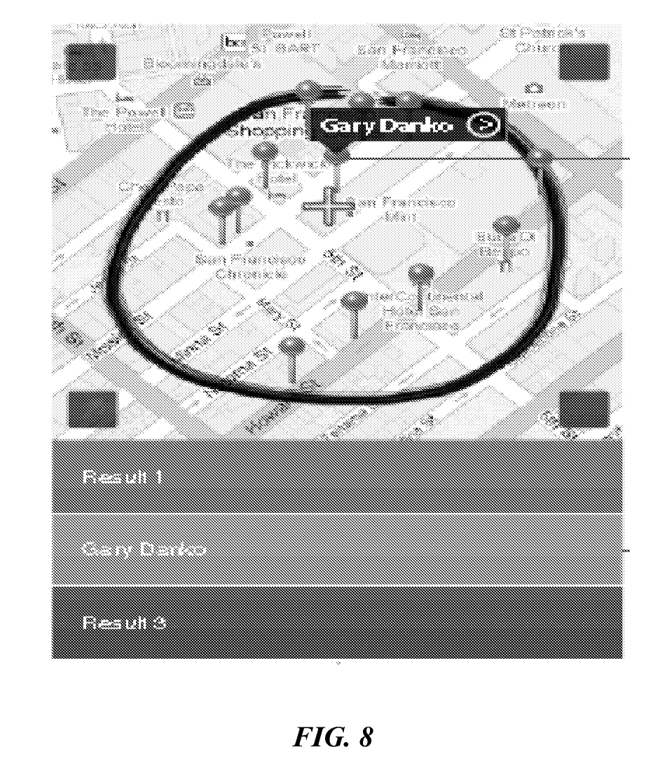

Processing the search is preferably enabled by a back-end search operation such as, but not limited to, YAHOO!® Local Search. The search is processed by formulating a query for only those items of interest within the designated target area as drawn by the user. This brings us to step 170, the Results Mode screen as depicted in FIG. 8. The underlying technology for processing the search query tracks the search processing found in YAHOO!® Local Search. In Results Mode, the pins (or other icons) designating the locations of the query results drop onto the screen. Note that this is just one example of how the query results can be displayed in the viewport. Other indicators, such as flags, stars, banners, or logos (among others) can also be used. For example, if the items of interest involve a search for ATMS (automated teller machines), the query results can be indicated by dollar signs.

In the Results Mode, the lower area of the viewport transitions into the result list. The top item on the list is highlighted and a callout balloon is presented over the corresponding pin. The top 50 results are returned. If there are more than 20 relevant results the Filter Mode is automatically enabled, replacing the list view. The user can apply filters and in turn the results change real-time on the map display. Any interaction with the map surface or a pin will exit the filter mode and display the list view.

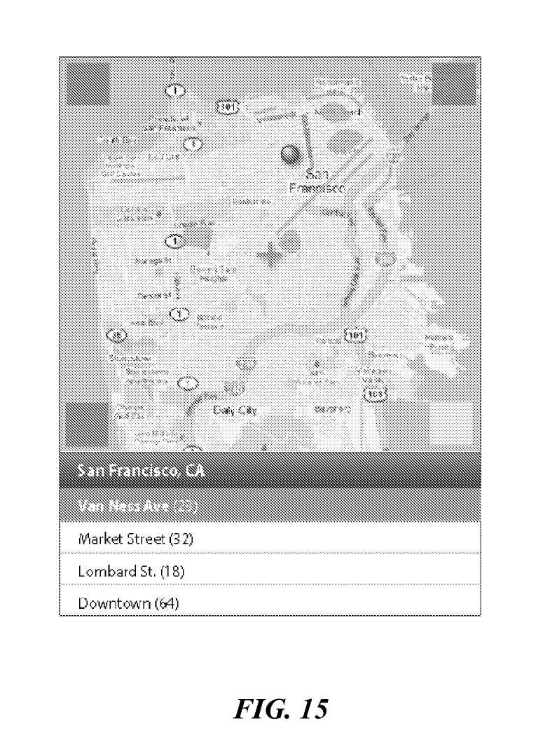

If the query turns up more than 50 results (or other designated threshold amount), at the bottom of the list is a “show more” that will return 20 (or other designated amount) more results and so on until the user is done or there are no more results to display. If the drawn area is too wide and the zoom factor is too low to show results then the system displays in Cluster Mode to further assist in locating the desired items of interest. See the “low zoom factor view and clustering” examples shown in FIGS. 15 through 18. If no results are found, an error message is displayed. The error message can be “nothing doing here. try another drawing.” or “no connection—oooops. please ensure that your device is connected to the internet and then try again.”

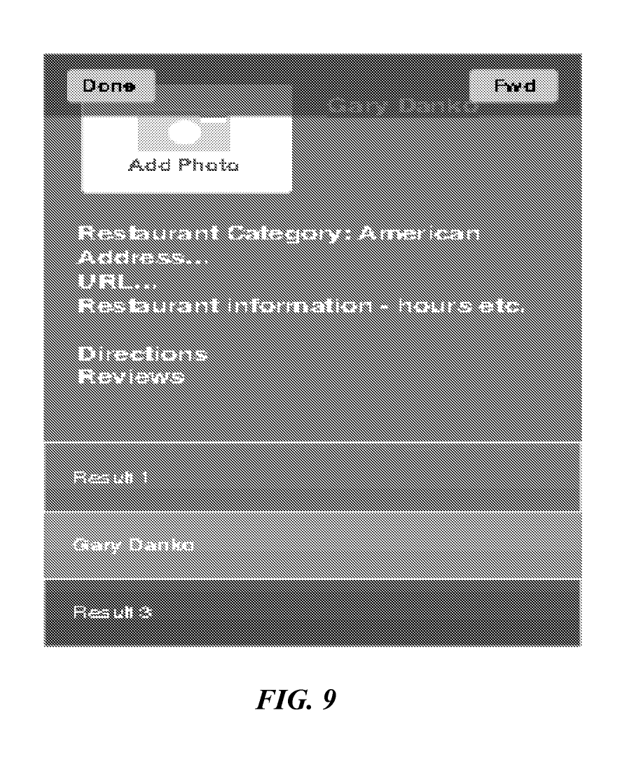

When results are returned, the following are shown in the viewport: a) result pins (or other indicators) appear and the overlay gets populated with results that match the pins as well; and b) the first ranked result and associated pin is highlighted. Note that the interaction between the pins and the map and the result items will function in a same or similar manner to that of the YAHOO!® Local Search application. Note that in the Results Mode, the user can click on a selected result for details about that result (shown in FIG. 9). In the alternative, some details may be displayed in the pin callout. The callout is the text box associated with the pin. A second tap lists the item. In the results screen, the favorites, filter, and location buttons become active (their status changes to enabled).

Even after results have already been displayed, the user is able to reposition the map. If the map is moved after the results appear: a) pins are only shown within the drawn area, even as the user repositions the map; b) objects are allowed to move out of the viewport as the user re-positions the map; c) as the user zooms in the drawing line is able to move out of the viewport; d) if the user selects another item from the results list while the object and pins are not within the viewport, then the object and pins will be brought back into the viewport and center the map on the pin associated with the item selected from the results list.

In the exemplary viewport example shown in FIG. 8, the restaurant “Gary Danko” is the second query result listed. If the user clicks on this result in step 180, the viewport presents details of the selected result. This is shown in FIG. 9 where the information for the restaurant “Gary Danko” is presented. In this Selected Result Mode the viewport now shows a local detail view (from YAHOO!® search app).

If a result is tapped the map screen gets replaced and shows detailed information, such as: location, rating, direction (button to a native Map app), phone/call (button to call), photos, business meta-data e.g. hours of operation, user reviews and more reviews link, email, and warning (business may be closed; business may be seasonal). In this mode the navigation bar is concealed. Clicking will reveal the navigation bar. The “done” button returns the user to the previous view; and the “fwd” button brings up an option to email the data. When the user clicks “done” the user is returned to the previous view. For example, if user navigated from filter view the user will be returned to filter view. Both the detail and list areas are scrollable.

Monetizing the search.

An important aspect of this search process is the ability to monetize the search. Selling a ranking of the search results is contemplated within the spirit and scope of the invention. Further, in another embodiment of the present invention, advertising can be displayed along with the search results (in the detail view screen). Additionally, it is possible to distinguish search results belonging to subscribers or other clients by using font attributes such as blinking, highlighting, bolding, color, and other attributes.

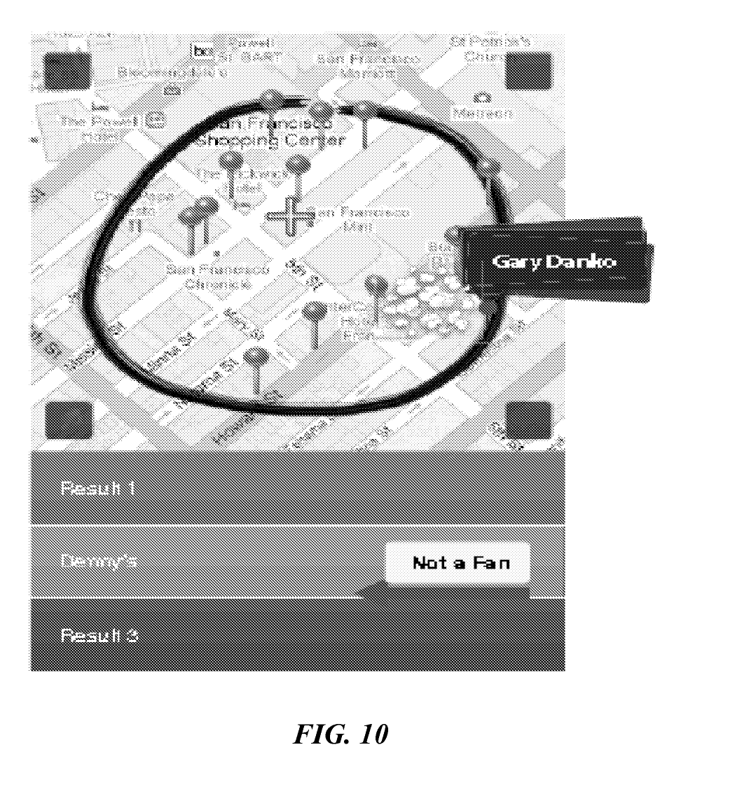

In step 190 the user can indicate that he/she rejects a displayed result. See FIG. 10 for a screenshot of the viewport in “Not a Fan” mode. There are two ways to indicate a rejection of the result. The first one is from the list items: a) swipe to the left on the list item to reveal a hide control that will remove that item from the map and the list and place it at the bottom of the list; and b) Hide “not a fan” businesses for future queries. The items selected for the “Not a Fan” category will be left out of any future queries. For example, if the user hit “Not a Fan” for a Denny's restaurant, then all Denny's restaurants (regardless of location) will be pushed down under a “not a fan” button that needs to be clicked to reveal them. No Denny's restaurants will be shown to the user even if they fall within the sketched search location.

The second way to indicate that you are not a fan is from the map itself: select a pin callout and hold it for more than 3 seconds; callout starts to shake; the pin is now movable and the user can throw (swoosh) it off the map; when user throws it off the map it “poofs” away; and after the user does this the first time a message such as “you can unhide this item in the list below by selecting the Unhide button” will appear. The unhide button is provided should the user change his/her mind and wish to see cast off item again. Next to the unhide button the number of hidden items will be displayed.

Filter mode.

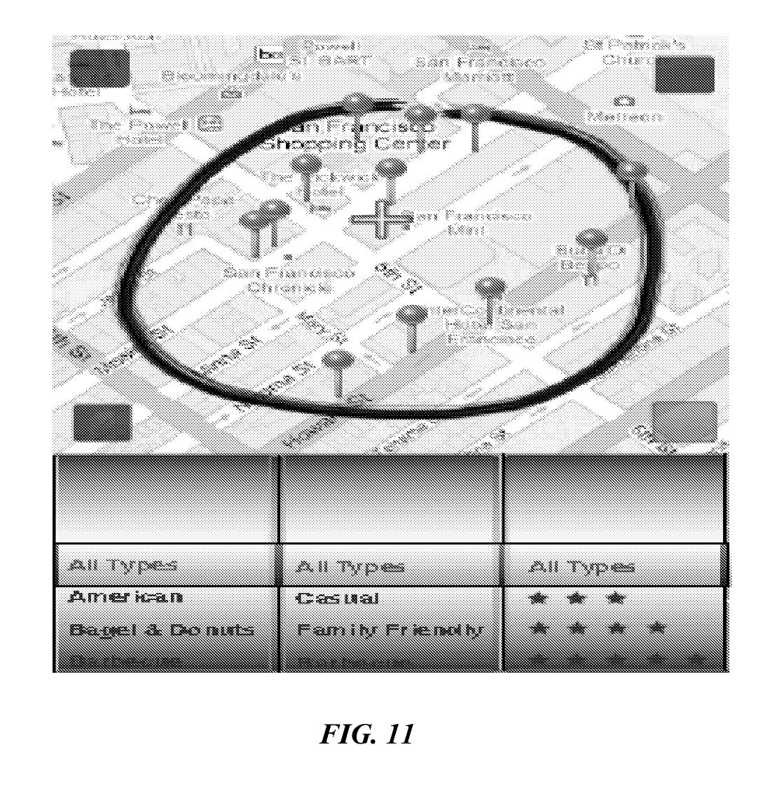

Once results appear on the screen, the filter and location buttons become active. See FIG. 11. In the Filter Mode example screenshot shown in FIG. 11, three scroll wheels appear with three selectable filters. Scrolling the wheel to different selections filters the results dynamically in the map. The filters will be limited to the selections actually available within the results set. The filter settings are set until changed when the user manually resets them or closes the app. Note that this is only one example of how Filter Mode can be enabled within the spirit and scope of the invention. Filter Mode can also display drop down menu items for selection rather than the scrolling wheels.

To disengage the filter display: a) tap the filter button again; b) touch a pin or the map surface; and c) entering draw, places, or location modes. The error messages for the filter mode can be: a) no results message “no results found” b) no connection “unable to load map: please ensure that your device is connected to the Internet and then try again.”

Share and Social Poll Option.

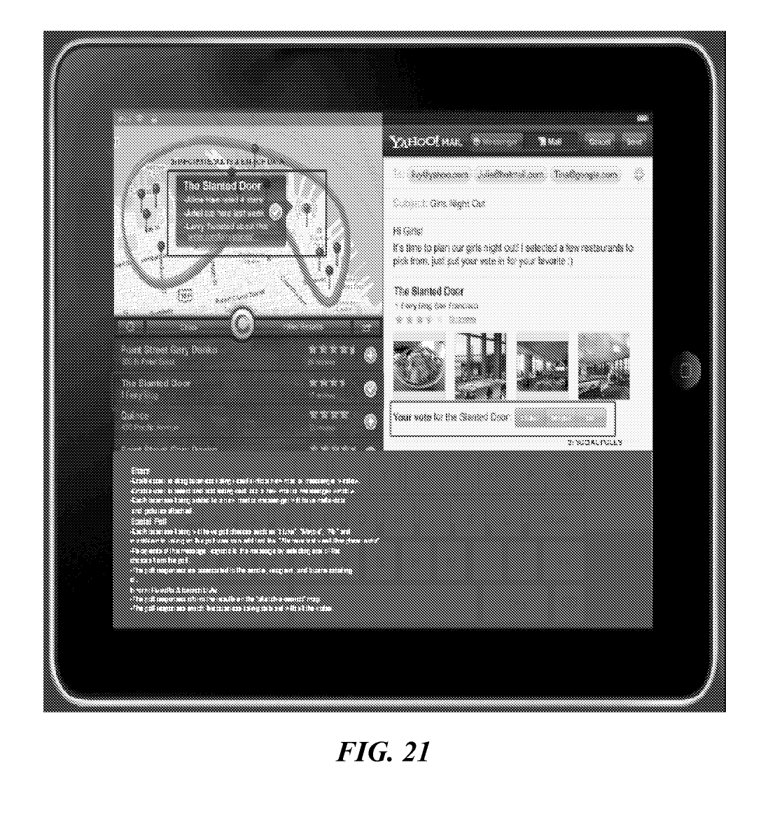

A further advantage of the sketch search feature is the ability for a user to share and poll the query results. Optionally in step 195 the user can select the share and social poll option, shown in FIG. 21. This option allows the user to share the search results with correspondents and conduct a social poll on the query results. To share the search results, the user can simply drag the resulting item of interest into a new mail or messenger window. The item's meta-data and any associated photos will also be attached. The user can share all the listing results or just select one result to share and/or poll.

The viewport in Poll Mode will show the business listing information along with poll choices such as “I Like,” “Maybe,” “No,” embedded into the mail/messenger capture and in addition to voting on the poll the user can add free-form text like “Ate here last week this place rocks!” In the example of FIG. 21 the user has written “Hi Girls! It's time to plan our girls night out! I selected a few restaurants to pick from, just put your vote in for your favorite :)” Recipients of the message respond to the message by selecting one of the choices from the poll.

The poll responses are associated with the sender, recipient, and business listing ID and are displayed in the detail view. The poll responses inform the user and the user's correspondents. The poll responses enrich the business listing data set with the votes and comments.

Finish Processing.

Lastly, in step 199 the user is able to start over or exit the search sketch app. The user can start over by depressing the draw mode button or clearing the drawing by shaking the touch screen device. Vigorously shaking the device will clear the drawing. Once the drawing is cleared the map mode once again becomes “drawable.” The screen will display fade animation of the drawn object slowly disappearing from the screen similar to erasing an etch-a-sketch board.

Places Mode.

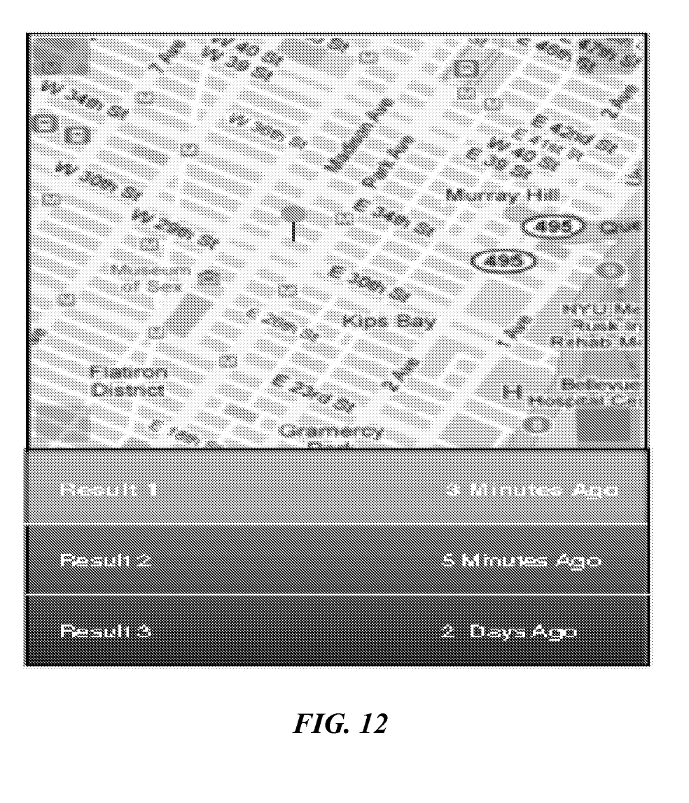

“Places Mode” is shown in FIG. 12. In Places Mode the places button is shown in the enabled state. Selecting “Places Mode” displays lists of items of interest that have been previously searched. The items to display are pulled from different sources. One source populates the “Places List” each time a user visits the local detail view. The viewed item will be pulled into the “Places List.” Another source option is if a previous search has been done the results are held while in this mode and displayed again when “Places Mode” is exited. Places Mode is similar to Results Mode in that, as the user selects items from a list the map view changes to the location of the selected item. In the initial state the most recently added item will be in the selected state and its associated pin will be centered on the map.

User customization.

The sketch search app can be customized with user preferences. For example, the user is able to select audio on or off; shake to clear on/off; and reset “not a fan” (are you sure dialog?). Other user customization features are contemplated within the spirit and scope of the invention.

Features.

The sketch search app remembers the last state when the session is resumed. When terminating the app it remembers the user's last state and on app start returns user to the last (suspended) state. The app works for the Apple iPod® mobile digital device touch users, except the call button is grayed out.

Locate Mode.

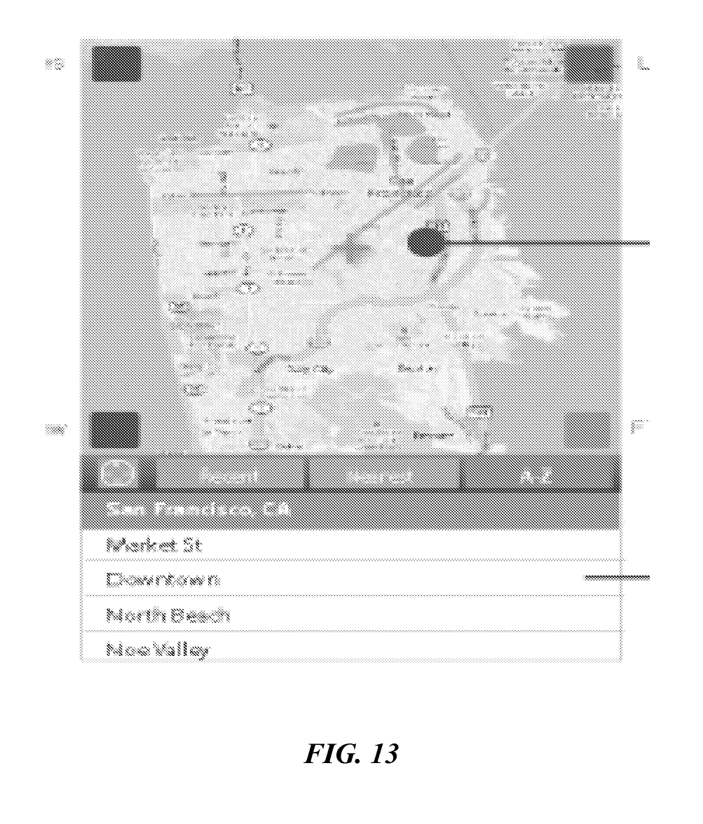

Returning to step 120, if the user selects “no” for the locate me prompt, FIG. 13 shows the initial Locate Mode screen. Note that the locate box shows the enabled state. Now, in Locate Mode, the default selection of San Francisco CA is shown (selected by geo-location). The default sort is A-Z. Recent and nearest are disabled unless there has been recent activity and the user has given location permission respectively. If these are tapped while disabled, messages are presented, “You have no recent activity,” “May we use your current location.” The user can also directly interact with the map or enter the draw or places modes.

Cluster Mode.

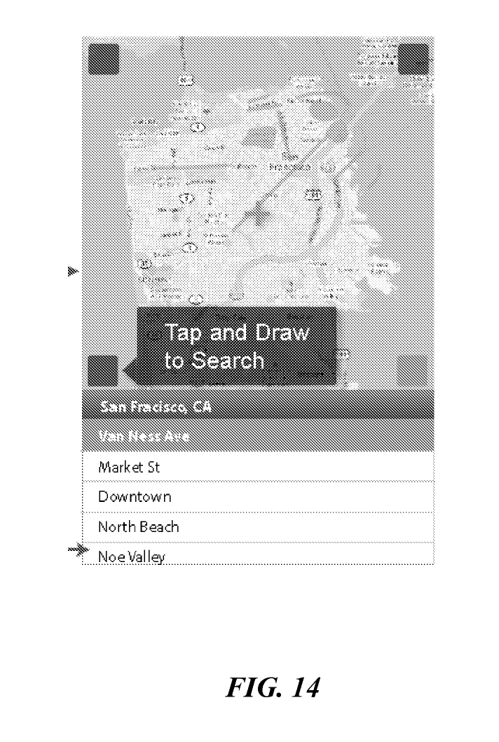

Referring to FIG. 14, selecting a metro new area location centers the map on that area and displays the draw prompt. Touching the map or a highlighted list item exits Locate Metro Mode. The cluster list is displayed in the lower area of the screen. If the user's location is known the map is zoomed to a level that shows good map detail, individual results display capably and they are centered. The app here will default to the location of the user. It uses a location hierarchy of neighborhood within city, within metro area, such as Metro area: SF Bay area; city: San Francisco, and neighborhood: Noe Valley. Multiple metro areas are supported.

The items of interest clusters are algorithmically generated along a specific street or neighborhood. A cluster can be defined as 20+items of interest results within a 0.5 mile area. If more than 60% (or other threshold amount) of the items of interest within the cluster area are located on a single street then the cluster is labeled with the name of the street e.g. University Ave., else the cluster is named by the lowest level neighborhood e.g. downtown Palo Alto. The designated cluster name can appear overlaid on the cluster image, or show in the results list in the lower portion of the viewport. In another embodiment, the cluster name may be hidden from view due to space constraints and revealed by a roll-over on the cluster callout.

Low Zoom Factor Pre-Draw Mode.

FIG. 15 shows the low zoom factor pre-draw view. At lower zoom factors it is not possible to show individual results. Therefore below a specified threshold the display will present significant clusters of results rather than individual ones. If a user is operating at a low zoom factor over a wide area he/she is probably looking for what areas are good for searching as opposed to individual results. We add information sent to aid users by visually showing significant clusters of potential results on the map to help guide the user to where some, but not all, fertile areas might be for sketching a search. Individual streets as well as areas can be called out. Smaller clusters may be formed or disseminated into individual results at various zoom factors. This would be determined by a density/viewport size ratio or whatever method is technically optimal. It should be noted that the cluster call outs are not clickable and they do not auto draw a selection. The user must still position the map using the conventional pinch-and-zoom map interaction and define a specific search area by drawing. The user can highlight clusters on the map by selecting list items.

Zoom and Position by Cluster Mode.

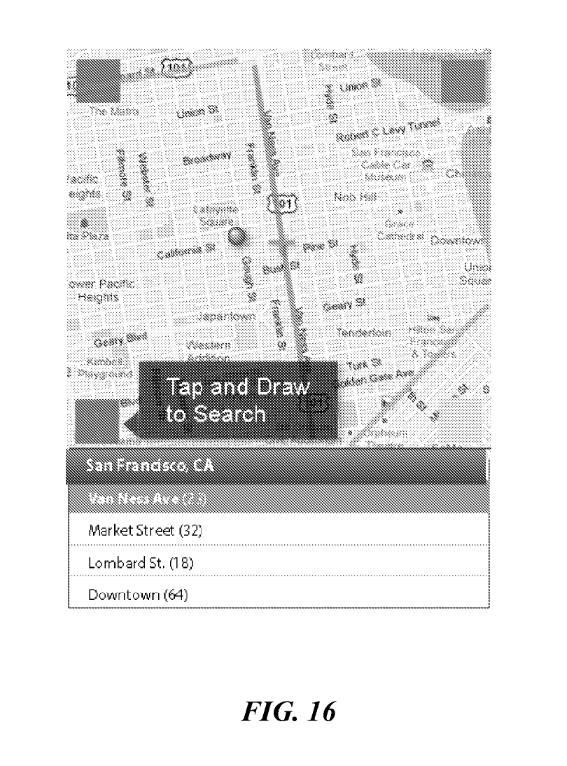

FIG. 16 shows the zoom and position by cluster mode. Tapping an already highlighted list item will zoom and position that cluster optimally within the map viewport for drawing. Clicking on a new list item or on its callout repeat the behaviors listed above.

The Low Zoom Factor Draw Mode.

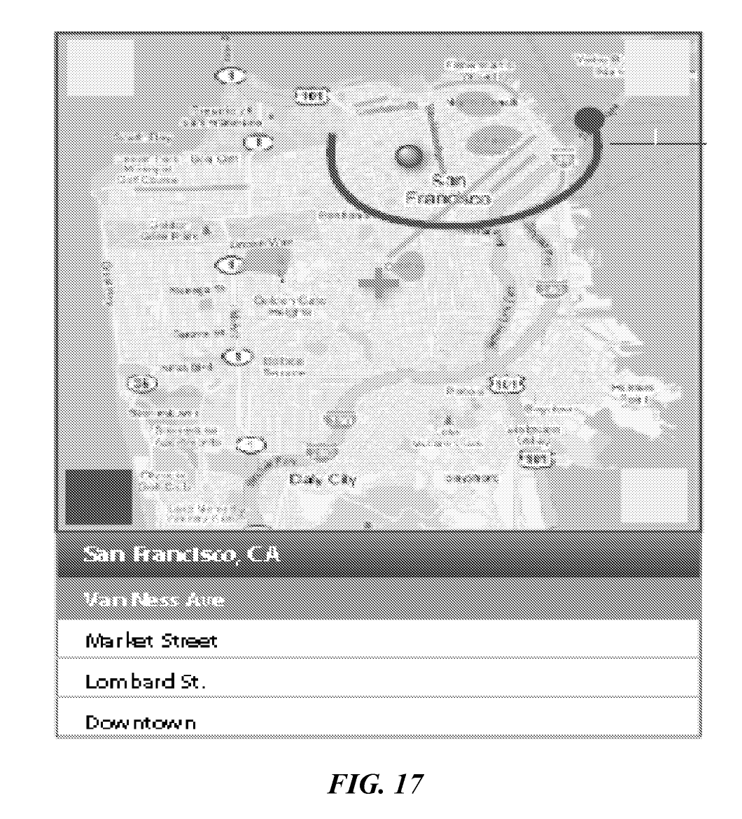

The Low Zoom Factor Draw Mode is shown in FIG. 17. Once a desired search area has been drawn the map auto-zooms to maximize the drawn area within the viewport to the highest possible degree of resolution.

Low Zoom Factor Drawn Area Auto-Zoom Mode.

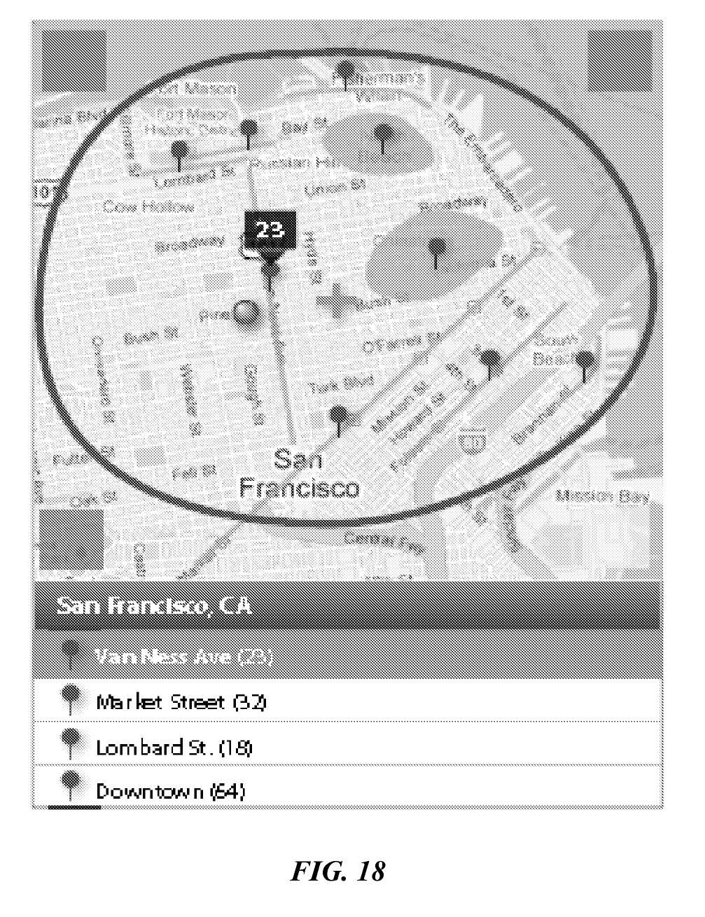

The low zoom factor drawn area auto-zoom mode is exemplified in FIG. 18. If the area is still too wide to show individual results, a “clustered” pin will drop into the clusters within the drawn area. The cluster at the top of the list or the one nearest the user, if the location is known, is highlighted and also shows a pin icon and number of results found. The corresponding pin on the map will also display a balloon with the number of results it represents.

The user can pinch and zoom in beyond the threshold at which individual results are shown. Or, the user can tap on a highlighted list item or corresponding pin on the map to zoom in over that area at a zoom factor that can show individual pins. If the user's location is known the pins are centered. If not the densest part of the cluster is centered. If an un-highlighted cluster is selected from the list item the drawing and results are retained and the map repositions to optimize that cluster in the map viewport. No results are shown in areas outside the drawn area.

Line Draw Mode.

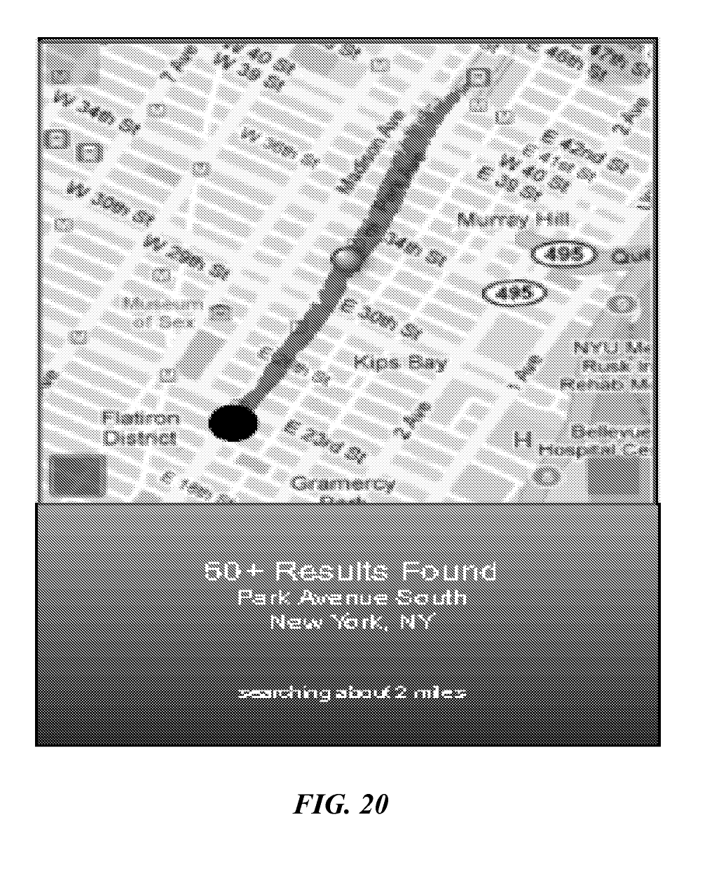

FIG. 20 shows the “line draw” mode. Here the user has sketched a line to represent an area to search. The line can only be drawn within the current viewport and must be attached to a closest street. Only one line is allowed per search. A predetermined margin around the drawn line is computed and the area within the computed margin is used as the search area. The results pane shows the number of results and the area covered by the line prior to returning the query results. The audio will make the same sounds as described with the circle object (if audio is selected).

Device Embodiments.

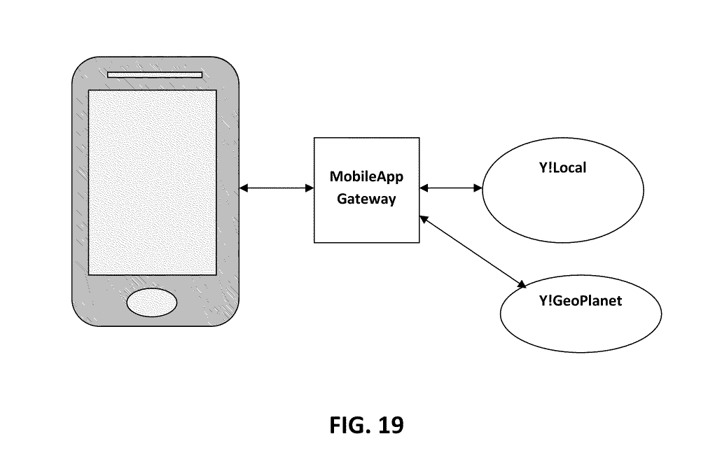

FIG. 19 is a simplified depiction of the sketch search device according to one embodiment of the present invention. The device shown in FIG. 19 is similar to a mobile phone 1910 such as the wildly popular iPhone® digital device by Apple Inc. The phone 1910 is in operative communication with a mobile app gateway 1920 for providing application support through seamless mobile connectivity to enterprise resources. The gateway 1920 can include, or be coupled with, a firewall and proxy server. The gateway 1920 also carries out essential activities related to mobile device management and provides connectivity to required exemplary back-end applications such as a search application 1940 such as YAHOO!® Local Search search engine and a geo-locator function 1960 such as YAHOO!® Geo-Planet® geographic search, both by YAHOO!® Inc.

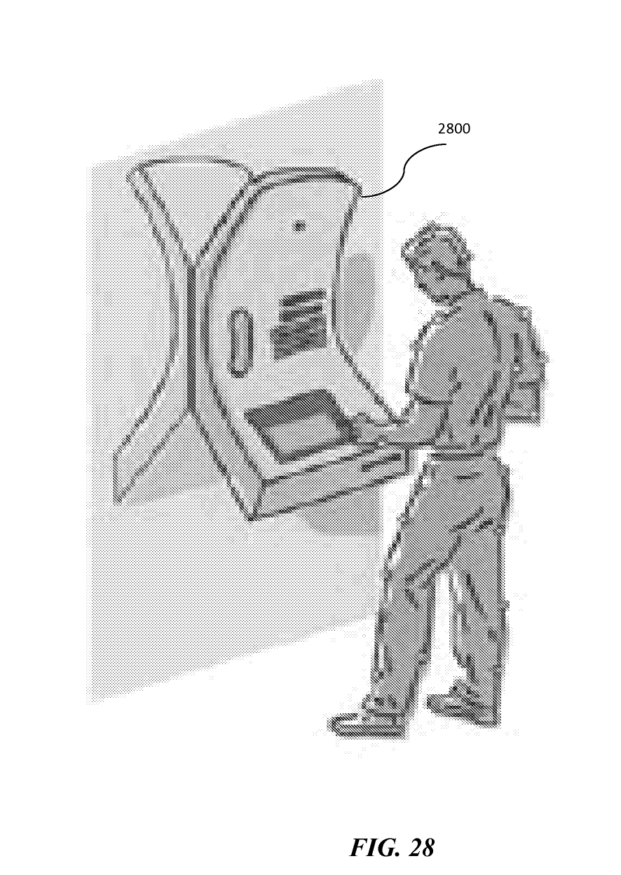

FIG. 28 is a simplified depiction of the sketch search device according to another embodiment of the present invention. In this embodiment, the sketch search functionality is operable on a touch screen kiosk 2800 (mall guide). The touch screen kiosk 2800 operates in a similar manner to the mobile phone embodiment. A user approaches the touch screen kiosk 2800 and selects the operations to perform by tapping/touching the screen. This embodiment is ideally suited for placement in tourist centers, shopping malls, major transportation gateways (airports, metro stations, bus terminals), hospitals, and universities. The sketch search operation, when selected on the kiosk 2800 can automatically default to the location of the kiosk 2800, similar to the “You are Here” location indicator found in mall directories. The user is then able to override the default search location and perform all of the functions as previously described.

In this implementation of the sketch search system, the polling feature can provide richer results because a larger number of users and correspondents can participate in the polling, generating more meaningful results. Additionally, the kiosk embodiment has tremendous monetizing potential.

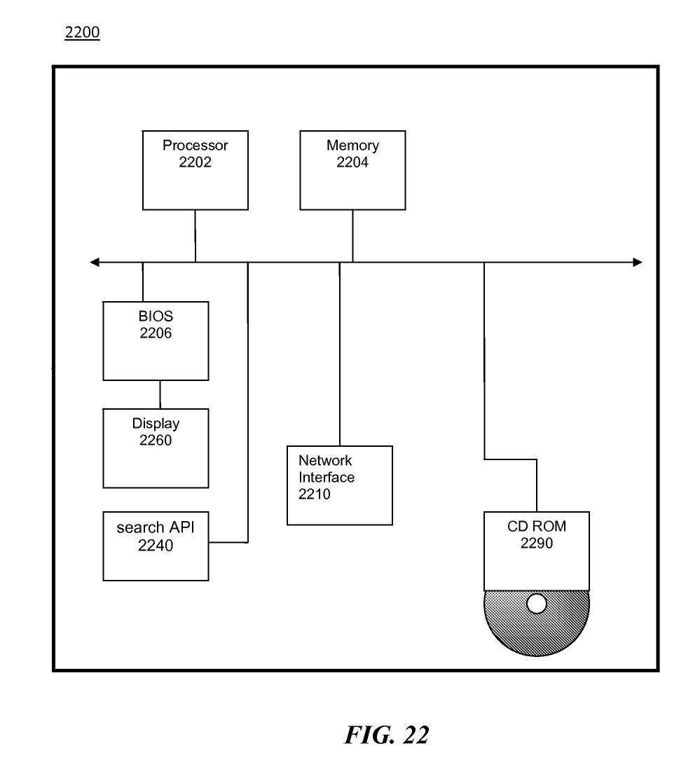

Referring now to FIG. 22, there is shown, according to an embodiment of the present invention, a simplified block diagram of a device 2200, such as a cell phone, laptop, or touch screen kiosk, configured to carry out the above-described processes. Device 2200 can be a cell phone, personal digital assistant, MPG3 player, laptop, touch screen kiosk or other apparatus with a touch screen display and logic for operating the touch screen display. Device 2200 also includes an interface 2240 to a mapping/locator feature such as YAHOO!® Geo-Planet® geographic search and YAHOO!® Local Search search engine, both by YAHOO!® Inc.

The mapping/locator feature and the search feature may be embodied in software, hardware, or firmware. They may be bundled with the device 2200 or accessible over the Internet using using mobile app device software. Device 2200 includes inter alia a processor device (apparatus) 2202 embodied in hardware, a memory 2204, and an input/output subsystem 2206. The processor device 2202 is operationally coupled with the input/output subsystem 2206, the touch screen display 2260, and the memory 2204. Memory 2204 may include both volatile and persistent memory for the storage of: operational instructions for execution by processor device 2202, data registers, application storage and the like. The input/output subsystem includes various user interfaces and the underlying logic for their operation (drivers, etc.), such as the touch screen, mouse, keyboard, and others.

Device 2200 includes a network interface 2210 for enabling operability of internet-dependent applications and may include a computer program product such as CD/DVD ROM 2290 or other removable media.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer-readable medium such as CDROM 2290 that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

What has been shown and discussed is a highly-simplified depiction of a programmable computer apparatus. Those skilled in the art will appreciate that other low-level components and connections are required in any practical application of a computer apparatus capable of performing the described invention.

1. A computer-implemented search method comprising steps of:
using a processor device operatively coupled with a touch screen display for:
receiving information required to render a first map of a geographical area on the touch screen display;
delivering the map for presentation on a first visual area rendered on the touch screen display;
receiving from a user of the touch screen display a selection of a target search area within the geographical area, wherein the user desires to restrict a search for items of interest to said target search area, wherein said selection of the target search area is produced by the user drawing a shape encompassing at least a portion of the target search area over the first map presented on the touch screen display;
responsive to receipt of the drawing:
accepting the shape of the drawing;
recognizing the shape as a boundary; and
identifying the boundary as representing the target search area for restricting the search;
executing a search for the items of interest located only within the boundary, wherein said search is executed on a query comprising the items of interest and the target search area, wherein said query excludes any items of interest not located within the target search area; and
returning query results to the user by indicating on the touch screen display those results matching the items of interest located within the boundary represented by the drawn target search area.

2. The computer-implemented search method of claim 1 wherein delivering the map for presentation further comprises:
delivering, on the first visual area, a first mode image button for presentation, wherein selecting said first mode image button by the user indicates the first operating mode and wherein an appearance of the mode image button indicates its state.

3. The computer-implemented search method of claim 2, further comprising:
receiving a selection of the first mode image button for enabling the user to draw the shape.

4. The computer-implemented search method of claim 1 further comprising:
setting a current location of the user as a default location for the geographical area.

5. The computer-implemented search method of claim 1 wherein recognizing the shape as a boundary further comprises:
recognizing the shape as an incomplete boundary;
causing an auto-complete operation to render a complete boundary using a trajectory of the incomplete boundary; and
identifying the complete boundary as the boundary for restricting the search.

6. The computer-implemented search method of claim 1 further comprising:
receiving a selection of a query result; and
delivering a graphical image on the touch screen display comprising information about the selected query result.

7. The computer-implemented search method of claim 1 wherein returning the query results comprises delivering within the drawn target search area icons associated with the items of interest located within the drawn target search area.

8. The computer-implemented search method of claim 1 wherein returning the query results further comprises delivering a textual representation of the items of interest on a second visual area of the touch screen display.

9. The computer-implemented search method of claim 1 further comprising:
receiving from the user an indication of rejection of a query result;
removing the item of interest associated with the rejected query result from any future queries; and
obscuring the query result such that said query result is no longer visible as a query result for this and future searches.

10. The computer-implemented search method of claim 1 wherein returning the query results further comprises:
displaying clusters of query results if it is not possible to display individual query results; and
identifying the clusters with a name descriptive of a location of the cluster.

11. The computer-implemented search method of claim 7 further comprising a social interaction feature wherein delivering the graphical image further comprises presenting, along with said graphical image, a selection button for actuating display of an electronic message window and when said selection button is pressed, dragging the graphical image to said electronic message window for transmitting the graphical image to a correspondent of the user.

12. The computer-implemented search method of claim 10 further comprising:
grouping the clusters responsive to a lower zoom factor; and
disseminating the clusters into individual query results responsive to a higher zoom factor.

13. The computer-implemented search method of claim 11 further comprising:
presenting, on the electronic message window, haptically-enabled polling choices for allowing the correspondent to vote on the selection of the query result by selecting a polling choice.

14. A system for computed-implemented search comprising:
a device comprising:
an input/output subsystem comprising a touch screen display;
a processor device operatively coupled with the input/output subsystem, said processor device operable for:
receiving information required to render a first map of a geographical area on the touch screen display;
delivering the map for presentation on a first visual area rendered on the touch screen display;
receiving from a user of the touch screen display a selection of a target search area within the geographical area wherein the user desires to restrict a search for items of interest to said target search area, wherein said selection of the target search area is produced by the user drawing a shape encompassing at least a portion of the target search area over the first map presented on the touch screen display;
responsive to receipt of the drawing:
accepting the shape of the drawing;
recognizing the shape as a boundary; and
identifying the boundary as representing the target search area for restricting the search;
executing a search for the items of interest located within the boundary, wherein the search is executed on a query comprising the item of interest and the target search area, wherein said query excludes any items of interest not located within the target search area; and
returning query results to the user by indicating on the touch screen display those results matching the items of interest located within the boundary represented by the drawn target search area; and
memory for storage of operational instructions for execution by the processor device.

15. The system of claim 14 wherein the processor device is further operable for delivering the map for presentation by:
delivering, on the first visual area, a first mode image button for presentation, wherein selecting said first mode image button by the user indicates the first operating mode and wherein an appearance of the mode image button indicates its state.

16. The system of claim 15 wherein the processor device is further operable for
receiving a selection of the first mode image button for enabling the user to draw the shape.

17. The system of claim 14 wherein the processor device is further operable for:
setting a current location of the user as a default location for the geographical area.

18. The system of claim 14 wherein the processor device is further operable for recognizing the shape as a boundary by:
recognizing the shape as an incomplete boundary;
causing an auto-complete operation to render a complete boundary using a trajectory of the incomplete boundary; and
identifying the complete boundary as the boundary for restricting the search.

19. The system of claim 14 wherein the processor device is further operable for:
receiving a selection of a query result; and
delivering a graphical image on the touch screen display comprising information about the selected query result.

20. The system of claim 14 wherein the processor device is further operable for:
returning the query results by delivering within the drawn target search area icons associated with the items of interest located within the drawn target search area.

21. The system of claim 14 wherein the processor device is further operable for returning the query results by delivering a textual representation of the items of interest on a second visual area of the touch screen display.

22. The system of claim 14 wherein the processor device is further operable for:
receiving from the user an indication of rejection of a query result;
removing the item of interest associated with the rejected query result from any future queries; and
obscuring the query result such that said query result is no longer visible as a query result for this and future searches.

23. The system of claim 14 wherein the processor device is further operable for returning the query results by:
displaying clusters of query results if it is not possible to display individual query results; and
identifying the clusters with a name descriptive of a location of the cluster.

24. The system of claim 19 wherein the processor device is further operable for activating a social interaction feature wherein delivering the graphical image further comprises presenting, along with said graphical image, a selection button for actuating display of an electronic message window and when said selection button is pressed, dragging the graphical image to said electronic message window for transmitting the graphical image to a correspondent of the user.

25. The system of claim 23 wherein the processor device is further operable for:
grouping the clusters responsive to a lower zoom factor; and
disseminating the clusters into individual query results responsive to a higher zoom factor.

26. The system of claim 22 wherein the processor device is further operable for:
presenting, on the electronic message window, haptically-enabled polling choices for allowing the correspondent to vote on the selection of the query result by selecting a polling choice.

27. A computer program product comprising a non-transitory computer readable medium comprising program instructions which, when executed, cause a computing device to:
receive information required to render a first map of a geographical area on the touch screen display;
deliver the map for presentation on a first visual area rendered on the touch screen display;
receive from a user of the touch screen display a selection of a target search area within the geographical area, wherein the user desires to restrict a search for items of interest to said target search area, wherein said selection of the target search area is produced by the user drawing a shape encompassing at least a portion of the target search area over the first map presented on the touch screen display;
responsive to receipt of the drawing:
accept the shape of the drawing;
recognize the shape as a boundary; and
identify the boundary as representing the target search area for restricting the search;
execute a search for the items of interest located only within the boundary, wherein said search is executed on a query comprising the items of interest and the target search area, wherein said query excludes any items of interest not located within the target search area; and
return query results to the user by indicating on the touch screen display those results matching the items of interest located within the boundary represented by the drawn target search area.
